(19) United States
(12) Patent Application Publication
(10) Pub. No.: US 2007/0146208 A1
(43) Pub. Date: Jun. 28, 2007

(54) ANTENNA HAVING PATCH ARRAYS INTEGRALLY FORMED WITH A NETWORK THEREOF

(76) Inventors: Kuan-Wei LEE, Hsin-Tien Taipei (TW); Tsung-Wen Chiu, Hsin-Tien Taipei (TW); Fu-Ren Hsiao, Hsin-Tien Taipei (TW); An-Chia Chen, Hsin-Tien Taipei (TW); Chih-Jen Hsiao, Hsin-Tien Taipei (TW)

Correspondence Address: Kao H. Lu, 1425 E.Darby Rd., Havertown, PA, 19083, US

(21) Appl. No.: 11/470,592

(22) Filed: Sep. 6, 2006

(30) Foreign Application Priority Data
Dec. 23, 2005 (TW) 094222497

(51) Int. Cl. H01Q 1/38

(52) U.S. Cl. 343/700 MS

(57) ABSTRACT

The present invention relates to an antenna, in which the metallic patches and the feed network are spaced apart from the ground plate. The metallic patches as well as the feed network and the ground plate board define a space therebetween, thus the antenna has better pattern and grain effects. Furthermore, the most important technique feature consists in that the metallic patches and the feed network are integrally formed by bending a single piece of metal plate, thus the present invention generates such effects therefore improving the design flexibility of the antenna and also simplifying the production process.

### BACKGROUND OF THE INVENTION

1. Field of the Invention

The present invention relates to an antenna having patch arrays, and more particularly to an antenna having patch arrays integrally formed with a network thereof.

2. Description of Related Art

With the fast development of the wireless communication, the demands for various antennas with different properties or features are increasing. The conventional microstrip antenna is formed by mounting thin metallic patches on the medium substrate with a ground plate on the opposite side thereof, usually using a feed network cable or coaxial probe to feed signals. The above metallic patches are usually thin foils with regular shapes, which maybe in shapes of a rectangle, a circle or an ellipse etc, the microstrip antenna can also utilize the metallic patches to form an array structure according to a certain regular arrangement. The pattern of a single metallic patch is difficult to control, and the grain is not high. Therefore array style is used to achieve the needed conditions. The technique principles of antennas are well known to the industry, so they are not described here any more.

At the present market, the microstrip antenna generally includes three parts: a ground plate, an SIMO (single in multiple out) feed network and at least a pair of twinned metallic patches. The feed network is connected electrically with the metallic patches respectively through different path lengths and different transmitting directions, when the electromagnetic signals are inputted in from the signal recourse, the signals will be feed to each of the metallic patches through the feed network, for the feed network length and the transmitting direction of each metallic patch is different, thus it would result in location and direction differences and also produce interference, simultaneously radiate the signals out thereby to achieve the objects and effects needed by the antenna.

In producing of the conventional microstrip antenna, it uses the PCB manufacture process to integrate the antenna with the microstrip cable, to integrate the metallic patches with the feed network, and printed on the circuit board, the opposite side of the circuit board is a ground plate. The advantage of this process consists in production simplicity, but it also makes the microstrip increases partial loss, and the radiation properties (including the grain and the sidelobe level) of the antenna are also decreased for this reason.

### SUMMARY OF THE INVENTION

The primary object of the present invention is to provide an antenna, in which the metallic patches and the feed network are integrally formed to simplify the production of the antenna.

Another object of the present invention is to provide an antenna, in which the metallic patches and the feed network are designed to be spaced apart from the ground plate, so as the metallic patches and the ground plate are separated by a resonance space.

Still another object of the present invention is to provide an antenna, wherein the metallic patches and the feed network are located at different levels, so as to increase the flexibility of antenna design.

The integral antenna of the present invention comprises a ground plate, a feed network and a plurality of metallic patches. The metallic patches are arranged in pairs, the feed network is connected electrically with the metallic patches, and the feed network and each pair of metallic patches have a particular design of path respectively, wherein the metallic patches and the feed network are formed by bending an integral piece of metal plate, and the metallic patches and the feed network are located at different levels.

In order for the examiners to better understand the spirits and technical features of the present invention, a preferred embodiment with attached drawings is given hereinafter in detail.

### BRIEF DESCRIPTION OF THE DRAWINGS

FIG. 1 is a top view showing an integrated antenna according to a preferred embodiment of the present invention; and

FIG. 2 is a side view showing the integrated antenna shown in FIG. 1.

### DETAILED DESCRIPTION OF THE PREFERRED EMBODIMENTS

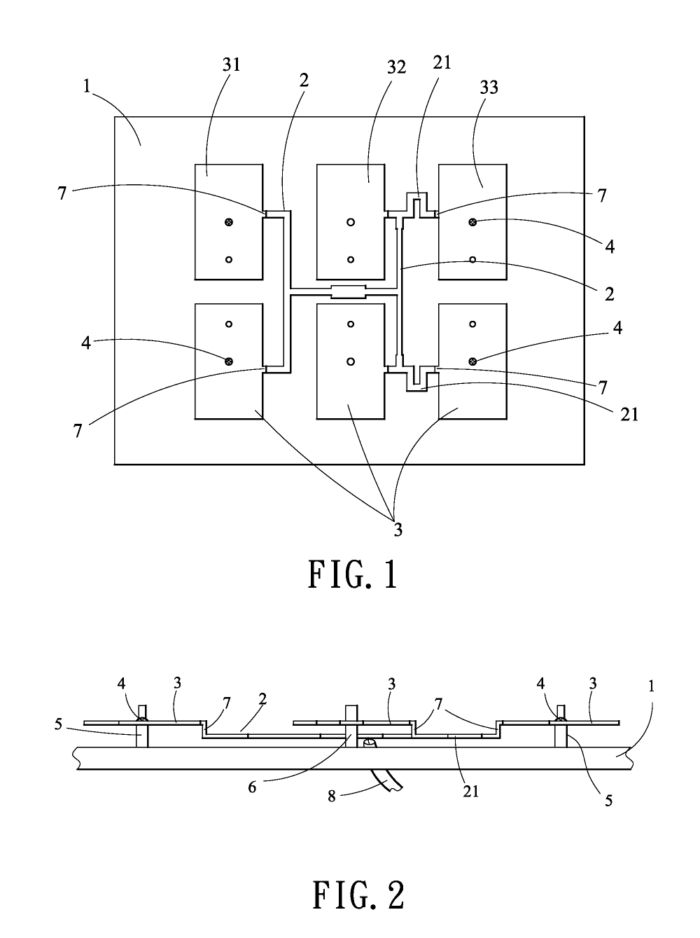

As shown in FIG. 1, an antenna according to a preferred embodiment of the present invention is proposed. The antenna of the present invention comprises a ground plate 1, a feed network 2 and a plurality of metallic patches 3. The plurality of metallic patches 3 includes three groups of symmetrical metallic patches 3, they are a first metallic patch group 31, a second metallic patch group 32 and a third metallic patch group 33 respectively, these metallic patch groups 31, 32 and 33 are arranged in array that is symmetrical in left and right. The feed network 2 are located among the metallic patches 3 and connected electrically with the first metallic patch group 31, the second metallic patch group 32 and the third metallic patch group 33 respectively. Judging from the top view, the overlooking projection arrangements of the metallic patches 3 and the feed network 2 are very much close to the arrangements that the conventional products print the radiation conductors and the feed network on the circuit boards, all just differs at the lengths of the feed network paths or the shapes of the radiation conductors, which can be achieved respectively by adjusting according to different band requirements. For the structure features of the present invention, please refer to FIG. 2, which shows a side view of an integral antenna of the embodiment according to the present invention. As shown in the side view, the metallic patches 3 and the feed network 2 of the present invention are located at different levels, and the metallic patches 3 and the feed network 2 are separated by a certain distance. In the present embodiment, it is through the fixing posts 5 and the screws 4 that the metallic patches 3 are fastened on the ground plate 1, and through a plurality of supporting posts 6 to support the metallic patches 3 respectively. The fixing posts 5 and the supporting posts 6 are disposed below the metallic patches 3 for supporting the metallic patches 3, to make the metallic patches 3 and the ground plate 1 define a certain space therebetween, the screws 4 pass through the metallic patches 3 and fasten the metallic patches 3 on the fixing posts 5. The material of the fixing posts 5 is metal, by connecting the fixing posts 5 and the screws 4 with the metallic patches 3 to make the metallic patches 3 to achieve a ground effect. As to the screws 4, they can be replaced by any other equivalent fastening elements. The supporting posts 6 are plastic posts that can be engaged with each other up and down have a function of supporting the metallic patches 3.

Furthermore, the level of the metallic patches 3 is higher than that of the feed network 2, and the relative distance between the metallic patches 3 and the feed network 2 can be adjusted according to the required conditions, and the relative distance between the metallic patches 3 and the ground plate 1 also can be adjusted according to the required conditions.

Besides, in the present invention, the metallic patches 3 and the feed network 2 are stamped and bent from an integral piece of metal. Through an single piece of metal, the shapes of the metallic patches 3 and the feed work 2 are punched out, then the vertical connecting portions 7 are formed by bending disposed between the metallic patches 3 and the feed network 2. In a specific embodiment of the present, the feed network 2 may be stamped in a form of H-shaped configuration and the portion thereof between the metallic patch groups 31 and 32 may be further formed with a U-shaped connection element 21 to increase the flexibility thereof. The vertical connecting portions 7 along with the metallic patches 3 and the feed network 2 are belonging to a same piece of metal plate, therefore it can secure the electrical connection between the metallic patches 3 and the feed network 2, and the feed coaxial cable 8 is connected with the feed network 2 so as to feed the signals.

The embodiments disclosed in the present invention are only illustrative and not limitative to the scope of the present invention. Therefore, any changes or modifications made by those skilled in the art via the description of the present invention without departing from the spirit of the invention are considered as like structures and covered by the claims of the present invention.

What is claimed is:

1. An antenna comprising:
a ground plate;
a feed network; and
a plurality of metallic patches arranged in pairs, the metallic patches electrically connected with the feed network and spaced apart from the ground plate to define a space therebetween;
wherein the metallic patches and the feed network are integrally formed by bending an single piece of metal plate, and the metallic patches and the feed network are located at different levels.

2. The antenna as claimed in claim 1, wherein said antenna further comprises a plurality of fixing posts disposed below said metallic patches, a plurality of supporting posts disposed below of said metallic patches for supporting said metallic patches, and a plurality of fastening elements securing said metallic patches onto said fixing posts.

3. The antenna as claimed in claim 1, wherein a vertical connecting portion is connected between the metallic patches and the feed network.

4. The antenna as claimed in claim 3, wherein the vertical connecting portion, the metallic patches, and the feed network are formed with a same piece of metal plate.

5. The antenna as claimed in claim 1, wherein the level of the metallic patches is higher than that of the feed network.

6. The antenna as claimed in claim 2, wherein the metallic patches are fastened on the ground plate by means of the plurality of fastening elements and fixing posts.

7. The antenna as claimed in claim 1, wherein a feed coaxial cable is connected with the feed network so as to feed the signals therefrom.

8. The antenna as claimed in claim 1, wherein the fixing posts and the fastening elements are made of metal, by connecting the fixing posts and the fastening elements with the metallic patches to make the metallic patches to achieve a ground effect.

9. The antenna as claimed in claim 1, wherein the feed network is formed in a H-shaped configuration to connect to the metallic patches.

10. The antenna as claimed in claim 9, wherein the feed network further comprises a U-shaped element connected between the second and third groups of the metallic patches.

11. The antenna as claimed in claim 2, wherein the supporting posts are made of plastic material engaged with each other up and down to support metallic patches.
